(19) United States
(12) Patent Application Publication
(10) Pub. No.: US 2017/0259818 A1
(43) Pub. Date: Sep. 14, 2017

(54) METHOD AND DEVICE FOR DETERMINING THE CROSS SLOPE OF A ROADWAY

(71) Applicant: Robert Bosch GmbH, Stuttgart (DE)

(72) Inventor: Matthias Freudenberger, Leonberg (DE)

(21) Appl. No.: 15/456,673

(22) Filed: Mar. 13, 2017

(30) Foreign Application Priority Data
Mar. 11, 2016 (DE) 102016204018.9

(51) Int. Cl. B60W 30/14

(52) U.S. Cl. CPC B60W 30/146; B60W 2520/14; B60W 2520/125; B60W 2520/10; B60W 2720/125; B60W 2720/14; B60W 2720/10; B60W 2550/146; B60W 2550/148

(57) ABSTRACT

A method and a device is described for determining the cross slope of a roadway or a negotiated curve for a motor vehicle, an evaluation unit being suppliable with measured values of a yaw rate sensor, of a driving speed sensor and of a lateral acceleration sensor as input signals, and the evaluation unit ascertaining therefrom a cross slope of the presently traveled roadway in that the difference value is formed between a calculated and a measured lateral acceleration, from which the roadway cross slope is derivable. The ascertained value is supplied to an adaptive cruise controller or a system for vehicle dynamics control in order to predefine an acceleration or a deceleration.

### FIELD OF THE INVENTION

The present invention relates to a method and to a device for determining the cross slope of a roadway or a negotiated curve for a motor vehicle, an evaluation unit being suppliable with measured values of a yaw rate sensor, of a driving speed sensor and of a lateral acceleration sensor as input signals, and the evaluation unit ascertaining therefrom a cross slope of the presently traveled roadway in that the difference value between a calculated and a measured lateral acceleration is formed, from which the roadway cross slope is derivable. The ascertained value is supplied to an adaptive cruise controller or a system for vehicle dynamics control in order to predefine an acceleration or a deceleration.

### BACKGROUND INFORMATION

A method and a device for limiting the speed of a vehicle are known from DE 198 48 236 A1, a setpoint speed being ascertained within the scope of an iterative process as a function of the vehicle speed, maximum lateral acceleration and curve radius. This speed approaches a limiting speed at which the curve to be driven through may be negotiated safely. The speed of the vehicle is controlled as a function of this setpoint speed and the actual speed.

### SUMMARY

The core of the present invention is to provide a method and a device with the aid of which a cross slope of a roadway or a negotiated curve may be ascertained, and the speed of the vehicle is limited to a maximum permissible vehicle speed, which is determined as a function of the cross slope of the negotiated curve.

For the described method, it is advantageous that additionally at least one of the measured variables of yaw rate, vehicle longitudinal speed, measured lateral acceleration and/or friction coefficient of the pavement in the area of the negotiated curve is used for the actual roadway cross slope. Within the scope of the present invention, it is also possible to use arbitrary combinations of the listed measured variables to determine the actual roadway cross slope. Furthermore, the measured variables may be ascertained with the aid of different sensor types.

For example, the yaw rate may be determined with the aid of a yaw rate sensor, the vehicle longitudinal speed with the aid of a wheel speed sensor, an inertial sensor, a radar sensor which measures the relative speed of the ground, or with the aid of objects situated on the roadside, or by ascertaining the speed with the aid of GPS signals.

The measured lateral acceleration may be measured with the aid of an acceleration sensor, for example, as they are installed in vehicle dynamics control systems by way of example.

For example, the friction coefficient of the pavement may stem from a visual analysis of the roadway pavement situated ahead of the vehicle, alternatively or additionally transmitted from a database with the aid of a radio interface or supplied from a friction coefficient analysis of a vehicle dynamics control system installed in the vehicle.

Furthermore, it is advantageous that the actual cross slope of the roadway is determined while a curve is being negotiated. By directly determining the roadway cross slope, it is possible to react immediately to changing cross slopes in that accelerations or decelerations of the vehicle are made possible while the curve is being negotiated. This allows a speed limitation that is adapted at all times, and increases the driving safety.

Furthermore, it is advantageous that the ascertained, actual cross slope is used to determine a maximum curve speed. By ascertaining the actual cross slope, it is possible to establish a curve limiting speed which is adapted to the particular cross slope, and possibly to further conditions of the surroundings, and to thereby increase the driving safety.

Furthermore, it is advantageous that the acceleration or the deceleration of an adaptive cruise controller is regulated as a function of the actual roadway cross slope or the maximum curve speed determined therefrom. By relaying the cross slope value or the maximum curve speed ascertained therefrom to an adaptive cruise controller or a conventional cruise controller, it is also possible to limit the maximum speed in order to increase the driving safety when a higher, instantaneous speed value is predefined in a cruise controller, and this value is decreased for the duration of the curve negotiation to the lower, maximum curve speed.

Advantageously, it is provided for the ascertainment of the actual roadway cross slope that the difference value between the lateral acceleration value calculated from the yaw rate and the lateral acceleration value measured with the aid of the lateral acceleration sensor is calculated. By ascertaining a lateral acceleration value from the instantaneous yaw rate, a lateral acceleration is ascertained which was ascertained in a local vehicle coordinate system. As an alternative or in addition, it is also possible to use any other ascertainment of a vehicle lateral acceleration in a local vehicle coordinate system for the present invention. The lateral acceleration value measured with the aid of the lateral acceleration sensor, in contrast, is ascertained in a global coordinate system and may deviate from the lateral acceleration value which was ascertained in the local vehicle coordinate system. For the ascertainment of the cross slope of the roadway, it is advantageous if the difference value between the lateral acceleration value ascertained in a global coordinate system, which is measured by a lateral acceleration sensor, for example, and the lateral acceleration value ascertained in a local vehicle coordinate system, which is formed from a lateral acceleration value calculated from the yaw rate, for example, is calculated.

It is particularly advantageous that a cross slope angle is ascertained from the difference value. The difference value of the two lateral acceleration values also takes into consideration that the vehicle at the measuring point in time has a rotation about its longitudinal axis, i.e., a roll angle deviating from the horizontal. From the magnitude of the ascertained difference value, it is possible to directly infer a cross slope angle of the roadway.

Furthermore, it is advantageous that the device according to the present invention may supply at least one of the variables of measured values of a yaw rate sensor, of a driving speed sensor and/or of a lateral acceleration sensor as input signals to an evaluation unit, and the evaluation unit includes computation means with the aid of which a cross slope of the presently traveled roadway is ascertained. In this way, it is made possible that the method according to the present invention may be implemented in a device and may be carried out in a vehicle.

Furthermore, it is advantageous that means are provided which supply the maximum curve speed value to an adaptive cruise controller or a conventional cruise controller, and that the adaptive cruise controller or the conventional cruise controller includes a limiter, which limits the speed settable by the adaptive cruise controller or conventional cruise controller, if needed. In this way, it is possible that an acceleration by the cruise controller is prevented while a curve is being negotiated which, in terms of vehicle dynamics, does not allow any further acceleration of the vehicle, and thereby increasing the driving safety.

Furthermore, it is conceivable that an acceleration by the driver while negotiating a curve is limited if the vehicle has almost reached the ascertained maximum curve speed value. From the ascertained difference between the measured and the calculated lateral acceleration value, it is possible to ascertain a characteristic curve corresponding to the difference value in the limiter, in which the slope of the characteristic curve is influenced by the difference in the lateral acceleration values.

Furthermore, it is advantageous that means are provided which supply the maximum curve speed value to a device for vehicle dynamics control, and the vehicle dynamics control system decelerates individual wheels of the vehicle, if needed. As a result of this measure, it is possible to still safely negotiate a curve which was approached too fast and which steadily inclines toward the outside while it is being negotiated or has a curve radius which becomes increasingly smaller over the progression of the curve, since the vehicle is successively decelerated to the maximum speed while the curve is being negotiated. This avoids instabilities in the vehicle dynamics and increases the driving safety.

Furthermore, it is advantageous that the measured lateral acceleration is filtered in order to filter out measuring noise of the measured lateral acceleration signal. From the difference between the calculated, local lateral acceleration value and the measured, global lateral acceleration value, a slope of a parameterizable characteristic curve may be set, the greater the difference value between the calculated and the measured lateral acceleration value, the steeper the slope of the characteristic curve. In this way, the magnitude of the control deviation may affect the dynamics or agility of the presently still permissible acceleration of the vehicle. If the speed is still far off the limiting value, the system intervenes only very gently. In contrast, at driving speeds which are very close to the maximum permitted driving speed, the system intervenes more abruptly and more strongly in the driving process. As a result of the difference value between the calculated lateral acceleration and the measured lateral acceleration, furthermore a sign is influenced, which is negative, for example, when the curve is entered too fast, and positive when the vehicle's own speed is below the maximum speed. This difference value also allows the degree of the control intervention of the system according to the present invention to be adapted as a function of the instantaneous driving situation.

Of particular significance is the implementation of the method according to the present invention in the form of a control element which is provided for a control unit of a conventional or adaptive cruise control system of a motor vehicle. A program, which is executable on a computer, in particular on a microprocessor or signal processor, and suitable for carrying out the method according to the present invention, is stored on the control element. In this case, the present invention is thus implemented by a program stored on the control element, so that this control element provided with the program represents the present invention in the same manner as the method for whose execution the program is suitable. In particular, an electrical storage medium may be used as the control element.

Additional features, application options and advantages of the present invention are derived from the following description of exemplary embodiments of the present invention, which are shown in the figures of the drawings. All described or illustrated features, either alone or in any arbitrary combination, form the subject matter of the present invention, regardless of their summary in the patent claims or their back reference, and regardless of their wording or representation in the description or in the drawings.

### BRIEF DESCRIPTION OF THE DRAWINGS

FIG. 1 shows a schematic block diagram of one specific embodiment of the method according to the present invention.

FIG. 2 shows a schematic block diagram of one specific embodiment of the device according to the present invention.

FIG. 3 shows a schematic block diagram of a further specific embodiment of the device according to the present invention.

### DETAILED DESCRIPTION

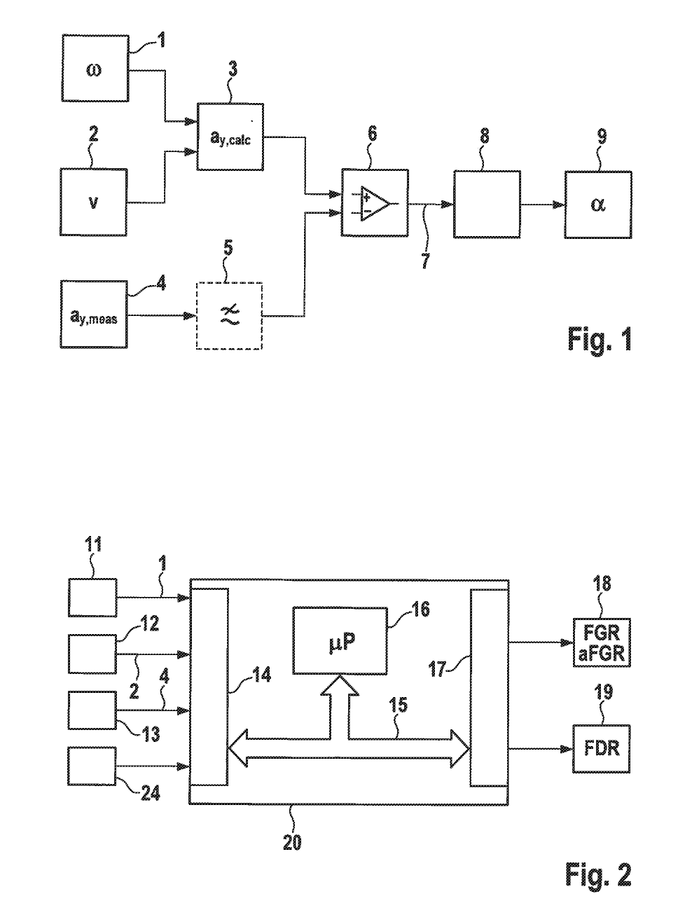

FIG. 1 shows a schematic block diagram in which, on the left-hand side, a first rectangle 1 for yaw rate ω and a second rectangle 2 for vehicle longitudinal speed v are provided as input variables. Yaw rate 1 may be obtained, for example, via a yaw rate sensor, which may be installed in a vehicle usually including a vehicle dynamics control system and thus indicate the rotational speed of the vehicle about its vehicle vertical axis. Vehicle longitudinal speed 2, which is usually also referred to as the vehicle speed, describes the speed of the vehicle in the direction of the vehicle longitudinal axis. This may be ascertained, for example, by averaging the multiple wheel speed sensors, but alternatively or additionally may also be calculated from a GPS signal or determined with the aid of a vehicle surroundings sensor, which, for example, detects reflections on the roadway surface or detects stationary objects on the roadside, and thus is able to ascertain the vehicle's own longitudinal speed via the relative speed of the stationary objects.

These two input signals yaw rate 1 and vehicle longitudinal speed 2 are supplied to a downstream rectangle 3, which is represented by the two arrows. In this downstream rectangle 3, local lateral acceleration a_{y,calc} is calculated, which moreover is referred to as calculated lateral acceleration 3. In this block 3, a calculated, local lateral acceleration a_{y,calc} is calculated from the knowledge of yaw rate 1 and vehicle longitudinal speed 2, for example using the equation a_{y,calc} =ωXV. Rectangle 4, which represents a global lateral acceleration a_{y,meas} measured with the aid of a sensor system, is represented also on the left-hand side of FIG. 1 as a further input variable. This measured lateral acceleration may be measured directly, for example with the aid of a lateral acceleration sensor, and is very common, frequently as part of a vehicle dynamics control system or a rollover detection system. This measured lateral acceleration signal a_{y,meas} may at times be very noisy, so that optionally filtering 5 may be provided, which is optionally represented in FIG. 1 by a dotted rectangle 5. Measured lateral acceleration signal a_{y,meas} in rectangle 4 is supplied to optional rectangle 5 in which an averaging of measured lateral acceleration signal a_{y,meas} over time is carried out, which corresponds to a low pass filtering. The output signal of this optional filter stage 5, like the output signal of the calculated, local lateral acceleration in rectangle 3, is supplied to a downstream difference creation device 6, which is again represented by the two arrows from rectangles 3 and 5 to rectangle 6.

In rectangle 6, a difference creation of the two supplied signals is carried out in that calculated, local lateral acceleration value a_{y,calc} and optionally filtered, measured, global lateral acceleration value a_{y,meas} are subtracted from one another. The result of this difference creation 6 is referred to as difference value 7 and forms the output signal of difference creation device 6.

This difference value 7 is the lateral acceleration difference between the global lateral acceleration, which was measured, and the local lateral acceleration, which was calculated, and represents a measure of the cross slope of the presently traveled roadway. Difference value 7 is supplied to a downstream rectangle 8 in which a conversion of the acceleration difference into an assigned cross slope angle takes place, which may be clearly assigned to difference value 7.

On the right-hand side of FIG. 1 rectangle 9 is illustrated, which as the result of the described method indicates a cross slope angle alpha α, which may advantageously be used for further settings and parameterizations in driver assistance systems or driver comfort systems.

FIG. 2 shows a schematic layout of a device with which the method according to the present invention may advantageously be carried out. An evaluation unit 20 is illustrated, for example, to which input signals 11, 12, 13, 24 shown on the left-hand side of FIG. 2 are supplied. An output signal 1 of a yaw rate sensor 11, which represents a yaw rate of the vehicle, is shown as input signals of evaluation unit 20. This yaw rate signal 1 of yaw rate sensor 11 is supplied to an input circuit 14 of evaluation unit 20. Output signal 2 of a longitudinal speed sensor 12, which may be designed as a wheel speed sensor, for example, and represents a vehicle longitudinal speed signal v, is also supplied to input circuit 14. Longitudinal speed sensor 12 may also alternatively or additionally be replaced or supplemented by an evaluation unit of a GPS signal, or replaced or supplemented by a surroundings sensor, which evaluates reflections on stationary objects and indicates the vehicle's own speed with the aid of the ascertained speed relative to stationary objects. As a further input signal, the output signal of a lateral acceleration sensor 13 is supplied to input circuit 14 of evaluation unit 20. This output signal 4 of lateral acceleration sensor 13 is a measured, global lateral acceleration a_{y,meas} and may optionally be filtered in lateral acceleration sensor 13 in order to eliminate measuring noise. Alternatively, it is also possible to supply measured, global lateral acceleration signal a_{y,meas} to input circuit 14 and to arithmetically filter an optional filtering in computation means 16 described hereafter. As a further, optional input variable, input circuit 14 of evaluation unit 20 may be supplied with a signal of a further sensor 24 for additional measured variables. Such a further sensor may be a friction coefficient sensor, for example, which indicates the friction coefficient of the presently traveled roadway surface. As a further sensor for additional measured variables 24, it may also be provided within the scope of the present invention that pieces of information are transmitted via a vehicle radio interface, which describe instantaneous, local roadway conditions and are kept available for retrieval on a storage means, for example a data server. For example, such values may have been recorded and made available by vehicles which traveled the presently traveled route at an earlier point in time. It is also possible that the evaluation of a video image is provided as a further sensor 24, in which properties of the roadway are ascertained with the aid of image processing, or that a laser-based sensor is provided, which enables pieces of information with respect to the roadway situated ahead, by scanning with the aid of the laser beam and an evaluation of the ascertained pieces of information.

The input variables supplied to evaluation unit 20 with the aid of input circuit 14 are supplied by input circuit 14 via an internal data exchange device 15, which may be designed as a bus system, for example, to a computation means 16. Computation means 16 may be designed, for example, as a microprocessor or as a microcontroller or as an application-specific integrated circuit (ASIC) or as free programmable gate array (FPGA). In computation means 16, one or multiple output variables are calculated from the supplied input variables with the aid of a control program and are ascertained according to the described method according to the present invention. The output variables determined by computation means 16 are supplied to an output circuit 17 via internal data exchange device 15. Output circuit 17 outputs the output variables of evaluation unit 20 to downstream actuators or control units for actuators. Such downstream actuators or control units for actuators may be, for example, a conventional cruise controller (CC) 18 or an adaptive cruise controller (ACC) 18, and additionally or alternatively be designed as a vehicle dynamics control system 19. The output variables output with the aid of output circuit 17 are supplied to the particular control units of conventional cruise controller 18 or adaptive cruise controller 18, and additionally or alternatively to the control unit of vehicle dynamics control system 19, where the ascertained cross slope angle alpha a is further processed to increase the driving comfort and the driving safety.

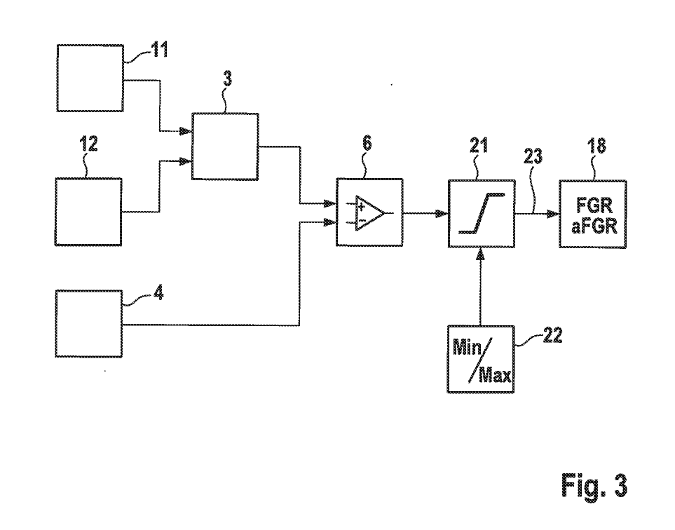

FIG. 3 shows a further specific embodiment of the system according to the present invention. Yaw rate sensor 11, which makes a yaw rate ω of the vehicle available as an output signal, is shown on the left-hand side of FIG. 3. Beneath, a longitudinal speed sensor 12, which may be designed as a wheel speed sensor, for example, is shown, which makes a vehicle speed signal v available as the output signal. The output signals of yaw rate sensor 11 and of speed sensor 12 are supplied to processing unit 3 in which a calculated, local lateral acceleration a_{y,calc} is calculated by multiplying the two input variables yaw rate ω and vehicle speed v with one another.

The output signal of this processing unit 3 is supplied as a first input signal to a difference creation device 6. Unit 4, which ascertains a measured, global lateral acceleration signal a_{y,meas} and makes it available as the output signal, is also shown on the left-hand side of FIG. 3. This output signal of lateral acceleration sensor 4 is supplied as a second input signal to difference creation device 6.

The two input signals are subtracted from one another in difference creation device 6, a difference

q=a_{y,calc}−a_{y,meas}

being calculated as the output signal. This difference value 7 ascertained in difference creation device 6 is supplied to a threshold value comparator 21, in which a characteristic curve having slope q is stored, which is derived from difference q, i.e., difference value 7. As a result, the slope of the characteristic curve of threshold value comparator 21 changes as a function of how far apart calculated, local lateral acceleration a_{y,calc} and measured, global lateral acceleration a_{y,meas} are from one another.

Due to the minimum/maximum value definition indicated in device 22, which may be stored as values in a control unit, for example, a minimum value and a maximum value are predefined for threshold value comparator 21, which each describe the maximum permitted lateral acceleration in the two lateral directions. Desired lateral acceleration a_{y,setpoint} is predefined via a further characteristic curve in threshold value comparator 21. From the difference of the two accelerations

aΔ=a_{y,setpoint}−a_{y,actual}

it is possible to ascertain a control deviation. If the curve is negotiated too fast, aΔ is negative, and adaptive cruise controller 18 must decelerate. If the curve is negotiated too slowly, aΔ is a positive value, and adaptive cruise controller 18 may continue to accelerate.

Using a setpoint speed value, which as future lateral acceleration setpoint value a_{y,setpoint} represents instantaneous lateral acceleration setpoint value a_{y,actual} plus the product of difference q and a settable factor f, i.e.,

a_{y,setpoint}=a_{y,actual}+q*f

this factor f representing the weighting of the influence of the road cross slope, it is possible to create an interface which allows universal execution between output circuit 17 of evaluation unit 20 and the input circuit of the control unit of a conventional or adaptive cruise controller (CC; ACC) 18 and an installation in arbitrarily parameterized and differently configured vehicles without major adaptation measures.

What is claimed is:

1. A method for determining a maximum permissible curve speed of a motor vehicle, comprising:
determining a maximum permissible vehicle speed as a function of a cross slope of a negotiated curve.

2. The method as recited in claim 1, wherein the determining is based on at least one of a yaw rate, a vehicle longitudinal speed, a measured lateral acceleration, and a friction coefficient of a pavement in an area of the negotiated curve.

3. The method as recited in claim 1, further comprising:
determining an actual roadway cross slope while the curve is being negotiated.

4. The method as recited in claim 1, wherein the determined actual roadway cross slope is used to determine a maximum curve speed.

5. The method as recited in claim 4, further comprising:
regulating one of an acceleration and a deceleration of an adaptive cruise controller as a function of one of the determined actual roadway cross slope and the maximum curve speed.

6. The method as recited in claim 1, further comprising:
calculating a first lateral acceleration value from a yaw rate;
measuring a second lateral acceleration value via a lateral acceleration sensor; and
calculating, for determining the actual roadway cross slope, a difference value from the first lateral acceleration value and the second lateral acceleration value.

7. The method as recited in claim 6, wherein a cross slope angle is ascertained from the difference value.

8. A device for determining a maximum permissible curve speed of a motor vehicle, comprising:
an arrangement for determining a maximum permissible vehicle speed as a function of a cross slope of a negotiated curve.

9. The device as recited in claim 8, further comprising:
an evaluation unit including a computation arrangement for ascertaining the cross slope of a presently traveled roadway, wherein measured values of a yaw rate sensor, of a driving speed sensor, and of a lateral acceleration sensor are suppliable as input signals to the evaluation unit.

10. The device as recited in claim 8, further comprising:
an arrangement for supplying a maximum curve speed value to an adaptive cruise controller, wherein the adaptive cruise controller includes a limiter that limits a speed settable by the adaptive cruise controller.

11. The device as recited in claim 8, further comprising:
an arrangement for supplying a maximum curve speed value to a system for vehicle dynamics control, wherein the vehicle dynamics control system decelerates individual wheels of the vehicle.
